(19) United States
(12) Patent Application Publication
(10) Pub. No.: US 2026/0179166 A1
(43) Pub. Date: Jun. 25, 2026

(54) NON-TRANSITORY COMPUTER-READABLE RECORDING MEDIUM, INFERENCE PROCESSING METHOD, MACHINE LEARNING METHOD, AND INFORMATION PROCESSING APPARATUS

(71) Applicant: Fujitsu Limited, Kawasaki-shi (JP)

(72) Inventor: Akira SAKAI, Kawasaki (JP)

(73) Assignee: Fujitsu Limited, Kawasaki-shi (JP)

(21) Appl. No.: 19/463,725

(22) Filed: Jan. 29, 2026

Related U.S. Application Data
(63) Continuation of application No. PCT/JP2023/028569, filed on Aug. 4, 2023.

(51) Int. Cl. G06Q 50/26; G06V 10/774; G06V 20/68

(52) U.S. Cl. CPC G06Q 50/265; G06V 10/774; G06V 20/68

(57) ABSTRACT

An information processing apparatus includes a control unit. The control unit acquires target analysis information indicating physical and chemical analysis results corresponding to an inspection target by inputting an inspection image from a nondestructive inspection on the inspection target to a first machine learning model trained by machine learning using a first data set of training data that associates an inspection image from a nondestructive inspection on first food with first analysis information indicating physical and chemical analysis results for the first food. The control unit infers sensory evaluation results corresponding to the inspection target by inputting the acquired target analysis information to a second machine learning model trained by machine learning using a second data set of training data that associates second analysis information indicating physical and chemical analysis results for second food with sensory evaluation results for the second food.

### CROSS-REFERENCE TO RELATED APPLICATION

This application is a continuation of International Application No. PCT/JP2023/028569, filed on Aug. 4, 2023, the entire contents of which are incorporated herein by reference.

### FIELD

The present disclosure relates to a non-transitory computer-readable recording medium, an inference processing method, a machine learning method, and an information processing apparatus.

### BACKGROUND

In the related art, there has been a move toward branding in food such as fruits by quantitatively evaluating quality and classifying grades. In such a food quality evaluation, the food is desirably inspected easily in a nondestructive manner not to damage the product value of an inspection target.

The related art for nondestructively evaluating the quality of an inspection target such as food is known to measure internal sugar content and acidity by using near-infrared spectroscopy.

An example of related-art is described in “Near-infrared Nondestructive Vegetable and Fruit Quality Checker F-750”, [online], [retrieved on July 27, 2023], Internet <URL:https://www.toyokokagaku.co.jp/product/development/fel ix/003.html>

### SUMMARY

An information processing apparatus includes a control unit. The control unit acquires target analysis information indicating physical and chemical analysis results corresponding to an inspection target by inputting an inspection image from a nondestructive inspection on the inspection target to a first machine learning model trained by machine learning using a first data set of training data that associates an inspection image from a nondestructive inspection on first food with first analysis information indicating physical and chemical analysis results for the first food. The control unit infers sensory evaluation results corresponding to the inspection target by inputting the acquired target analysis information to a second machine learning model trained by machine learning using a second data set of training data that associates second analysis information indicating physical and chemical analysis results for second food with sensory evaluation results for the second food.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram for explaining an outline of the processing of an information processing apparatus according to an embodiment.

FIG. 2 is a block diagram illustrating a functional configuration example of the information processing apparatus according to the embodiment.

FIG. 3 is a flowchart illustrating an operation example of the information processing apparatus according to the embodiment.

FIG. 4 is an explanatory diagram for explaining the training of an autoencoder.

FIG. 5 is an explanatory diagram for explaining the training of a first machine learning model.

FIG. 6 is an explanatory diagram for explaining the training of a second machine learning model.

FIG. 7 is an explanatory diagram for explaining the inference of evaluation results.

FIG. 8 is an explanatory diagram for explaining an example of a computer configuration.

### DESCRIPTION OF EMBODIMENTS

For quantification of food taste, a sensory evaluation using five tastes (sweet, umami, bitter, sour, and salty) is a standard method. However, the above related art only measures sugar content and acidity and does not perform the sensory evaluation using five tastes (sweet, umami, bitter, sour, and salty). In addition, the sensory evaluation is generally performed by an inspector by tasting food being an inspection target, and for practical purposes, performing a nondestructive and easy evaluation is difficult due to the loss of some food by a sampling inspection and the difficulty of securing skilled inspectors.

The following describes an inference processing program, a machine learning program, an inference processing method, a machine learning method, and an information processing apparatus according to embodiments with reference to the drawings. In the embodiments, the same reference signs are attached to components having the same functions, and redundant explanations thereof are omitted. Note that the inference processing program, the machine learning program, the inference processing method, the machine learning method, and the information processing apparatus to be described in the following embodiments are merely examples and are not limiting the embodiments. In addition, the following embodiments may be combined as appropriate to the extent that they are not inconsistent.

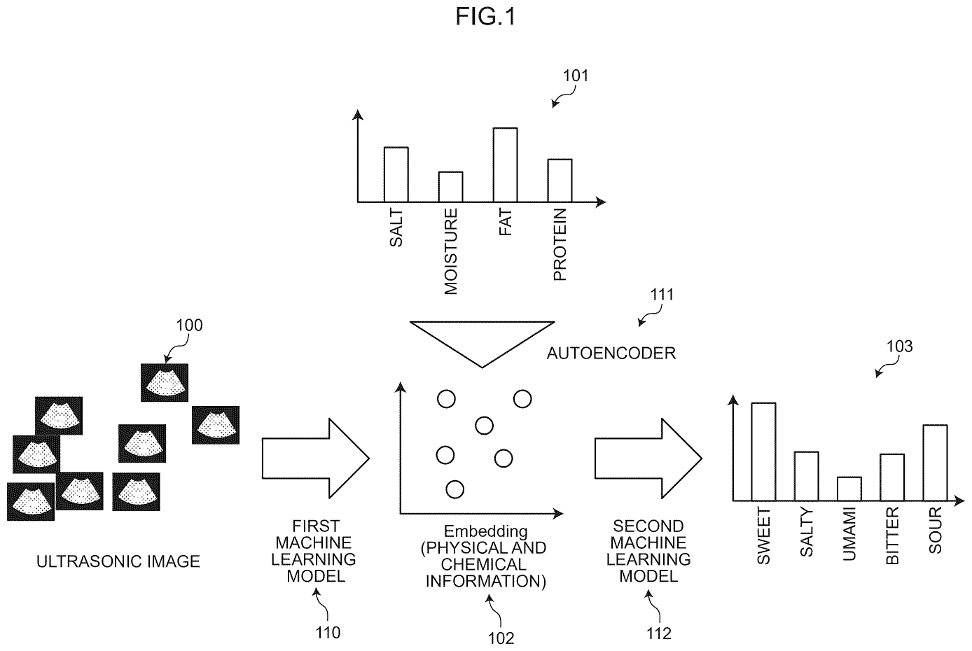

FIG. 1 is an explanatory diagram for explaining an outline of the processing of an information processing apparatus according to an embodiment. As illustrated in FIG. 1, the information processing apparatus according to the embodiment infers evaluation results 103 of sensory evaluation for five tastes (sweet, umami, bitter, sour, and salty) based on inspection image data 100 of an inspection image (an ultrasonic image in the illustrated example) obtained by a nondestructive inspection on an inspection target such food.

Note that the present embodiment to be described below exemplifies a case in which an ultrasonic image obtained by ultrasonic exploration such as an exploration probe to an inspection target is used as an inspection image, but the type of inspection image is not limited to ultrasonic images. For example, the inspection image may be a near-infrared image of the inspection target using near-infrared spectroscopy, a radiation image obtained by irradiating the inspection target with radiation, and a combination of these various inspection images. In addition, the ultrasonic images may also be various mode images such as amplitude (A) mode images and brightness (B) mode images, and a combination of these various mode images.

The information processing apparatus according to the embodiment inputs the inspection image data 100 from a nondestructive inspection on the inspection target to a first machine learning model 110, thereby obtaining physical and chemical information 102 indicating the results of physical and chemical analysis corresponding to the inspection target.

The first machine learning model 110 is a model trained to output the physical and chemical information 102 corresponding to the inspection target in response to the reception of the inspection image data 100 of the inspection target by supervised machine learning using a first training data set for each case of food.

Specifically, the first training data set includes a case-by-case data set that combines inspection image data of inspection images from a nondestructive inspection on food with physical and chemical analysis data 101 indicating physical and chemical analysis results for the food.

The physical and chemical analysis data 101 is multidimensional data including, as the physical and chemical analysis results for the food, physical analysis results such as hardness and mass in addition to chemical analysis results such as salt, moisture, fat, and protein content.

When machine learning of the first machine learning model 110 is performed using such multidimensional physical and chemical analysis data 101, over-training, which is too suitable for the physical and chemical analysis data 101, may occur. Therefore, the information processing apparatus according to the embodiment dimensionally compresses the physical and chemical analysis data 101 included in the first training data set by an autoencoder 111 to generate Embedding (physical and chemical information 102). The physical and chemical information 102 generated in this way is data representing the features of the physical and chemical analysis results included in the physical and chemical analysis data 101 in a lower dimensional vector representation or the like.

When the inspection image data of the inspection images from the nondestructive inspection on the food is input to the first machine learning model 110, the information processing apparatus according to the embodiment performs machine learning of the first machine learning model 110 so that output from the first machine learning model 110 is the physical and chemical information 102 generated from the physical and chemical analysis data 101. Specifically, the information processing apparatus according to the embodiment adjusts parameters of the first machine learning model 110 by using a known machine learning algorithm such as an error back propagation method.

After the physical and chemical information 102 is obtained, the information processing apparatus according to the embodiment infers the evaluation results 103 of the sensory evaluation corresponding to the inspection target by inputting the physical and chemical information 102 to a second machine learning model 112.

The second machine learning model 112 is a model trained to output the evaluation results 103 of the sensory evaluation corresponding to the inspection target in response to the reception of the physical and chemical information 102 acquired from the inspection image data 100 of the inspection target by supervised machine learning using a second training data set for each case of food.

Specifically, the second training data set includes a case-by-case data set that combines the physical and chemical analysis data 101 indicating the physical and chemical analysis results for the food with the evaluation results of the sensory evaluation of the food.

The information processing apparatus according to the embodiment dimensionally compresses the physical and chemical analysis data 101 included in the second training data set by the autoencoder 111 to generate Embedding (physical and chemical information 102). Subsequently, the information processing apparatus according to the embodiment performs machine learning of the second machine learning model 112 so that when the generated physical and chemical information 102 is input to the second machine learning model 112, output from the second machine learning model 112 is the evaluation results of the sensory evaluation of the food. Specifically, the information processing apparatus according to the embodiment adjusts parameters of the second machine learning model 112 by using a known machine learning algorithm such as an error back propagation method, similar to the first machine learning model 110.

The information processing apparatus according to the embodiment infers the evaluation results 103 of the sensory evaluation in this way based on the inspection image data 100 from a nondestructive inspection on inspection targets, thereby making it possible to obtain the sensory evaluation of the inspection targets nondestructively and easily without causing some of the inspection targets to be lost due to a sampling inspection or securing skilled inspectors.

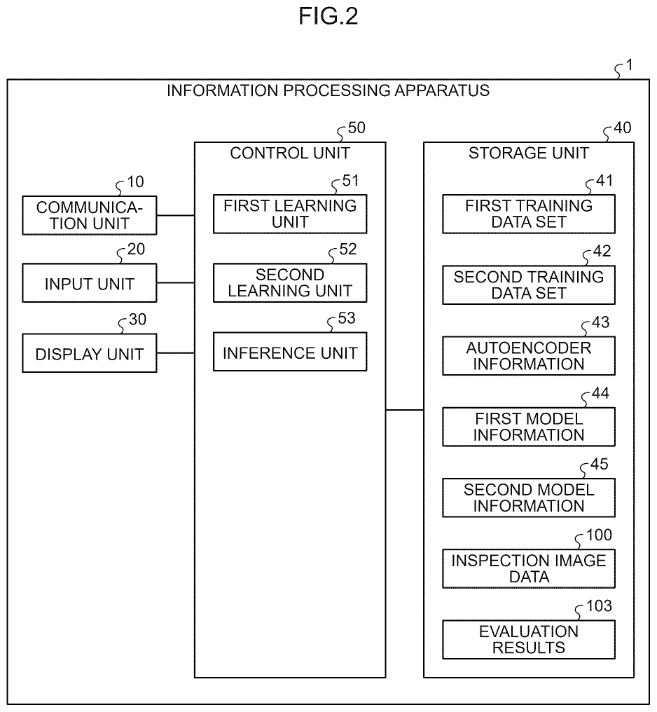

FIG. 2 is a block diagram illustrating a functional configuration example of the information processing apparatus according to the embodiment. As illustrated in FIG. 2, an information processing apparatus 1 includes a communication unit 10, an input unit 20, a display unit 30, a storage unit 40, and a control unit 50. For example, a personal computer (PC) or the like can be applied as the information processing apparatus 1.

The communication unit 10 executes data communication with external devices or the like via a network. For example, under the control of the control unit 50, the communication unit 10 acquires inspection image data 100 from a nondestructive inspection on an inspection target from inspection equipment (not illustrated) and stores the inspection image data 100 in the storage unit 40.

For example, when an ultrasonic exploration using an exploration probe is performed on the inspection target, ultrasonic image data obtained from the ultrasonic exploration is acquired from the inspection equipment as the inspection image data 100.

In addition, under the control of the control unit 50, the communication unit 10 acquires a first training data set 41 used for machine learning of the first machine learning model 110 and a second training data set 42 used for machine learning of the second machine learning model 112 from an external device such as a data server, and stores the acquired first training data set 41 and second training data set 42 in the storage unit 40.

The input unit 20 receives operations from a user. The display unit 30 displays the results of a process of the control unit 50. For example, the display unit 30 displays, on a display, the evaluation results 103 or the like inferred by an inference unit 53 of the control unit 50.

The storage unit 40 includes the first training data set 41, the second training data set 42, autoencoder information 43, first model information 44, second model information 45, the inspection image data 100, and the evaluation results 103. For example, the storage unit 40 is implemented with a memory or the like.

The first training data set 41 is a case-by-case data set that combines inspection image data of inspection images from a nondestructive inspection on food with physical and chemical analysis data indicating physical and chemical analysis results for the food.

The second training data set 42 is a case-by-case data set that combines the physical and chemical analysis data indicating the physical and chemical analysis results for food with evaluation results of a sensory evaluation of the food. Herein, the food in the first training data set and the food in the second training data set are the same type of food (for example, fish such as tuna and yellowtail and fruits such as watermelon and melon). However, the first training data set and the second training data set do not always have to be drawn from the same individual food sample.

The autoencoder information 43 is information on the autoencoder 111. The autoencoder information 43 includes, for example, the number of dimensions to be compressed. The autoencoder information 43 is set in advance by a user or the like.

The first model information 44 is information on various parameters regarding the first machine learning model 110. In the first model information 44, setting values of the parameters are updated by the machine learning of the first machine learning model 110 described above.

The second model information 45 is information on various parameters regarding the second machine learning model 112. In the second model information 45, setting values of the parameters are updated by the machine learning of the second machine learning model 112 described above.

The control unit 50 includes a first learning unit 51, a second learning unit 52, and the inference unit 53. For example, the control unit 50 is implemented with a processor.

The first learning unit 51 is a processing unit that performs machine learning on the first machine learning model 110 described above. The second learning unit 52 is a processing unit that performs machine learning on the second machine learning model 112 described above. The inference unit 53 is a processing unit that infers the evaluation results 103 of the sensory evaluation by using the first machine learning model 110 and the second machine learning model 112 based on the inspection image data 100 from the nondestructive inspection on the inspection target.

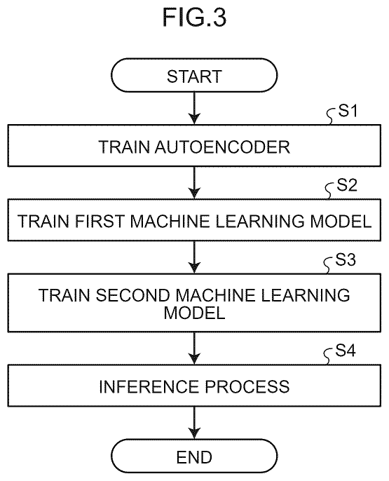

Details of the processes in the first learning unit 51, the second learning unit 52, and the inference unit 53 are described below. FIG. 3 is a flowchart illustrating an operation example of the information processing apparatus according to the embodiment.

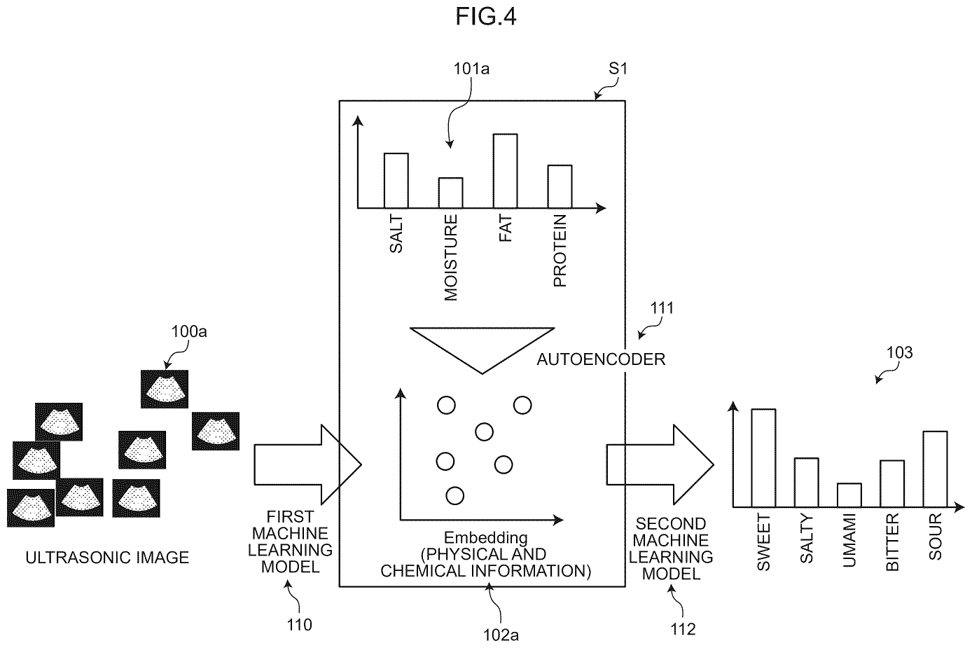

As illustrated in FIG. 3, when the process is started, the first learning unit 51 reads the first training data set 41 and trains the autoencoder 111 (S1). FIG. 4 is an explanatory diagram for explaining the training of the autoencoder 111.

As illustrated in FIG. 4, the first learning unit 51 inputs physical and chemical analysis data 101a included in the first training data set 41 to the autoencoder 111 and trains the autoencoder 111 so that data restored to the original dimension after dimensional compression is the physical and chemical analysis data 101a. The first learning unit 51 generates Embedding (physical and chemical information 102a) of the physical and chemical analysis data 101a by dimensional compression in this learning process.

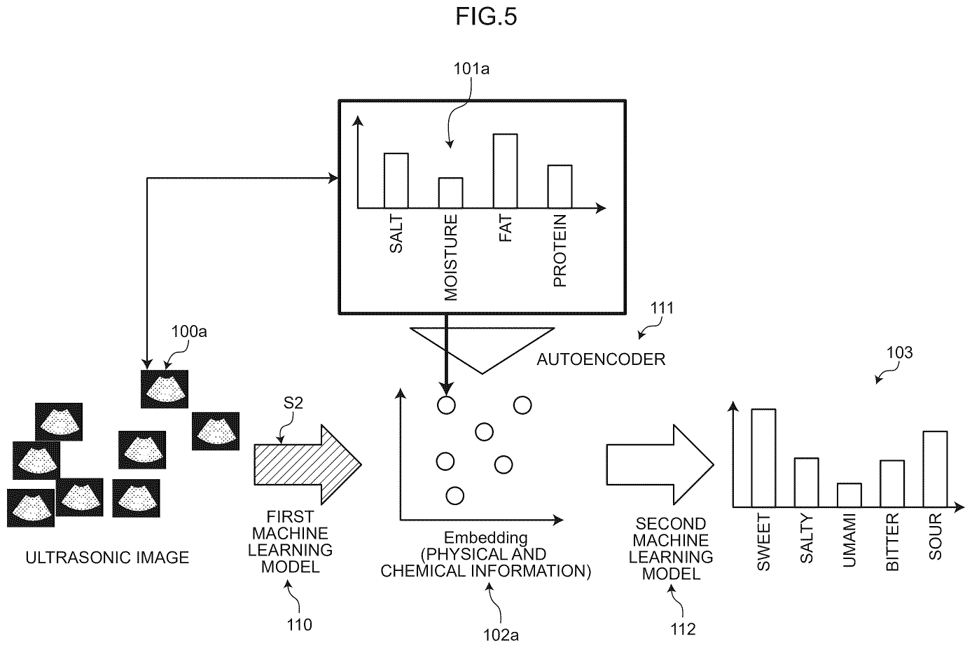

Returning to FIG. 3, subsequent to S1, the first learning unit 51 trains the first machine learning model 110 by using the first training data set 41 that has been read (S2). FIG. 5 is an explanatory diagram for explaining the training of the first machine learning model 110.

As illustrated in FIG. 5, the first learning unit 51 performs machine learning of the first machine learning model 110 so that when an inspection image data 100a included in the first training data set 41 is input to the first machine learning model 110, output from the first machine learning model 110 is the physical and chemical information 102a generated from the physical and chemical analysis data 101a. Herein, the first learning unit 51 stores parameters of the first machine learning model 110 obtained by the machine learning in the first model information 44.

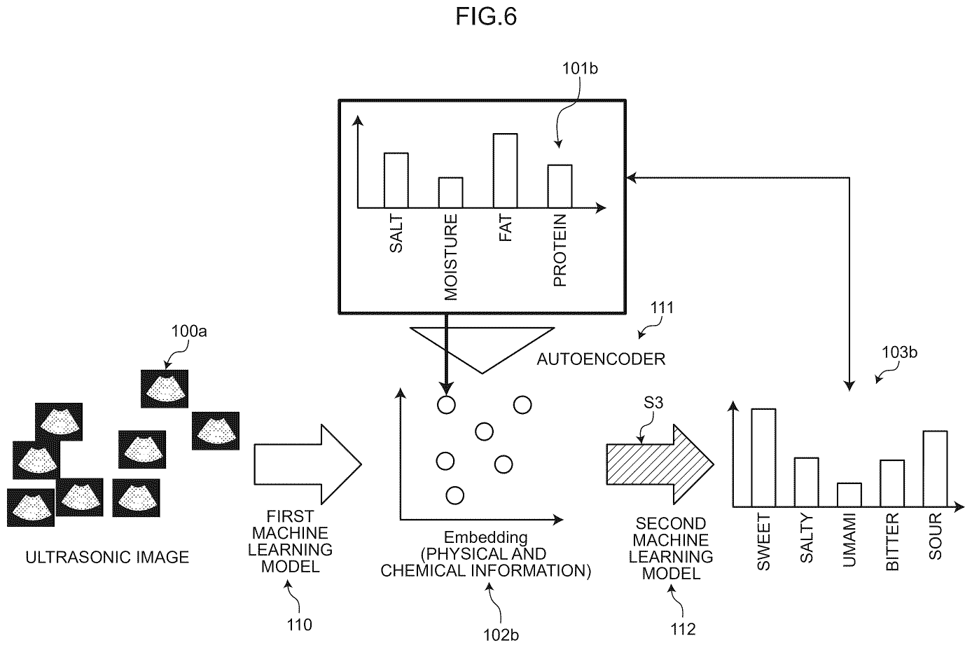

Returning to FIG. 3, subsequent to S2, the second learning unit 52 reads the second training data set 42 and trains the second machine learning mode 112(S3). FIG. 6 is an explanatory diagram for explaining the training of the second machine learning model 112.

As illustrated in FIG. 6, the second learning unit 52 inputs physical and chemical analysis data 101b included in the second training data set 42 to the autoencoder 111 for dimensional compression to generate Embedding (physical and chemical information 102b) of the physical and chemical analysis data 101b. Subsequently, the second learning unit 52 performs machine learning of the second machine learning model 112 so that when the generated physical and chemical information 102b is input to the second machine learning model 112, output from the second machine learning model 112 is evaluation results 103b included in the second training data set 42. Herein, the second learning unit 52 stores parameters of the second machine learning model 112 obtained by the machine learning in the second model information 45.

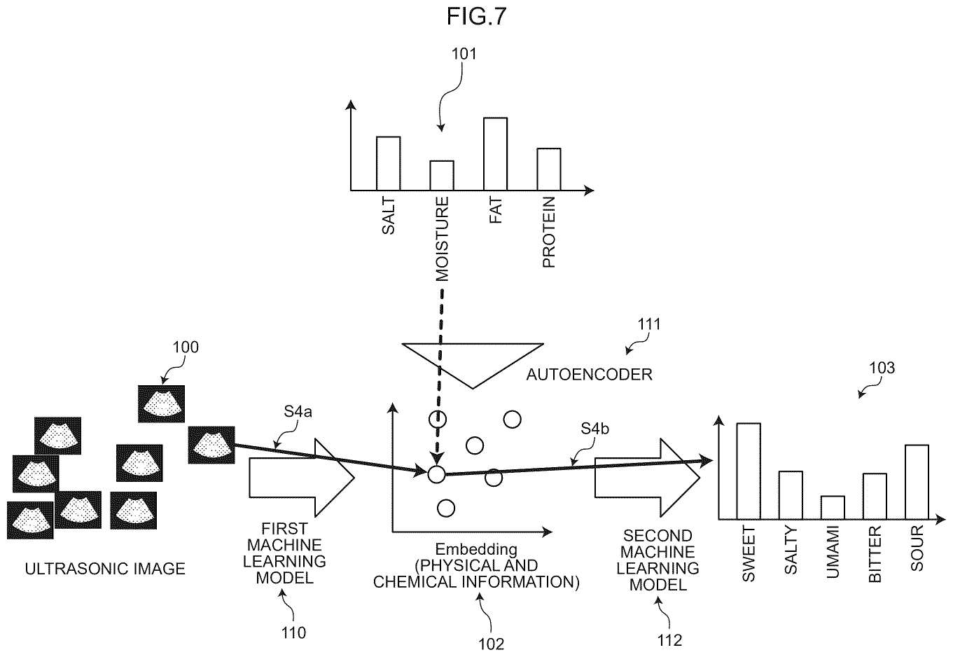

Returning to FIG. 3, subsequent to S3, the inference unit 53 performs an inference process of inferring the evaluation results 103 of the sensory evaluation by using the first machine learning model 110 and the second machine learning model 112 based on the inspection image data 100. FIG. 7 is an explanatory diagram for explaining the inference of the evaluation results 103.

As illustrated in FIG. 7, the inference unit 53 constructs the first machine learning model 110 and the second machine learning model 112 based on the first model information 44 and the second model information 45. Subsequently, the inference unit 53 reads the inspection image data 100 of the inspection target and inputs the read inspection image data 100 to the constructed first machine learning model 110. Thus, the inference unit 53 acquires the physical and chemical information 102 corresponding to the inspection target (S4a).

Subsequently, the inference unit 53 inputs the acquired physical and chemical information 102 to the constructed second machine learning model 112. Thus, the inference unit 53 infers the evaluation results 103 of the sensory evaluation corresponding to the inspection target (S4b). The inference unit 53 displays the inferred evaluation results 103 on a display or the like via the display unit 30. At this time, the inference unit 53 may output the physical and chemical information 102 via the display unit 30 together with the evaluation results 103 of the sensory evaluation corresponding to the inspection target.

As described above, the information processing apparatus 1 inputs the inspection image data 100 from the nondestructive inspection on the inspection target to the first machine learning model 110, thereby acquiring the physical and chemical information 102 indicating physical and chemical analysis results corresponding to the inspection target. Herein, the first machine learning model 110 is a model trained by machine learning using the first training data set 41 that associates inspection images from the nondestructive inspection on food with analysis information indicating physical and chemical analysis results for the food. By inputting the acquired physical and chemical information 102 to the second machine learning model 112, the information processing apparatus 1 infers the evaluation results 103 of the sensory evaluation corresponding to the inspection target. Herein, the second machine learning model 112 is a model trained by machine learning using the second training data set 42 that associates the analysis information indicating the physical and chemical analysis results for the food with sensory evaluation results for the food.

This allows the information processing apparatus 1 to obtain the sensory evaluation of inspection targets nondestructively and easily without causing some of the inspection targets to be lost due to a sampling inspection or securing skilled inspectors. As described above, in the present embodiment, the first training data set and the second training data set do not always have to be drawn from the same individual food sample. In the sampling inspection according to the related art, since the sensory evaluation is performed by an inspector by tasting food being an inspection target, the individual food sample being an inspection target is lost (unable to be shipped as an article). In the sensory evaluation described in the present embodiment, the individual food sample being an inspection target does not have to be tasted, and the sensory evaluation can be implemented with the nondestructive inspection, so that the loss of the individual food sample being an inspection target can be avoided in the sensory evaluation. In addition, the sampling inspection according to the related art is strictly limited to sensory evaluation of individual food samples that are not actually shipped. On the other hand, the sensory evaluation described in the present embodiment can be performed on shippable (defect-free) individual food samples. Note that the method of the sensory evaluation described in the present embodiment is applicable even when individual food samples for the first training data set and the second training data set are identical or when parts of the individual food samples for the respective training data sets are identical.

The first machine learning model 110 of the information processing apparatus 1 is trained by machine learning by using the physical and chemical information 102a obtained by dimensionally compressing the physical and chemical analysis data 101 of the food by the autoencoder 111. By training using the physical and chemical information 102 obtained by dimensionally compressing the physical and chemical analysis data 101 in this way, the information processing apparatus 1 can prevent over-training of the first machine learning model 110 too suitable for the physical and chemical analysis data 101 of the food.

By applying ultrasonic images obtained by ultrasonic exploration to the inspection image data 100, the information processing apparatus 1 can obtain the sensory evaluation of the inspection target nondestructively and easily by the ultrasonic exploration of the inspection target.

The information processing apparatus 1 outputs the physical and chemical information 102 together with the evaluation results 103 of the sensory evaluation. This allows a user of the information processing apparatus 1 to verify the relationship between the inspection image data 100 of the inspection target and the evaluation results 103 of the sensory evaluation through the physical and chemical information 102. That is, the explanatory power of the evaluation results 103 of the sensory evaluation is improved.

The information processing apparatus 1 trains the first machine learning model 110 by machine learning using the first training data set 41 that associates inspection images from the nondestructive inspection on food with analysis information indicating physical and chemical analysis results for the food. The information processing apparatus 1 trains the second machine learning model 112 by machine learning using the second training data set 42 that associates the analysis information indicating the physical and chemical analysis results for the food with sensory evaluation results for the food. This allows the information processing apparatus 1 to obtain the first machine learning model 110 and the second machine learning model 112 for inferring the evaluation results 103 of the sensory evaluation corresponding to the inspection target via the physical and chemical information 102 from the inspection image data 100 from the nondestructive inspection on the inspection target.

Note that each component of each device illustrated in the drawing does not always have to be physically configured as illustrated in the drawing. That is, the specific form of dispersion and integration of each device is not limited to that illustrated in the drawing, but can be configured by functionally or physically dispersing and integrating all or part thereof in arbitrary units according to various loads, usage conditions, and the like.

For example, the training of the autoencoder 111 (S1), the training of the first machine learning model 110 (S2), the training of the second machine learning model 112 (S3), and the inference process (S4) may be performed on separate information processing apparatuses.

In addition, various processing functions of the first learning unit 51, the second learning unit 52, and the inference unit 53 performed in the control unit 50 of the information processing apparatus 1 may be performed in whole or in any part on a CPU (or a microcomputer such as an MPU and a micro controller unit (MCU)). In addition, it goes without saying that the various processing functions may be performed in whole or in any part on a computer program that is analyzed and executed by a CPU (or a microcomputer such as an MPU or an MCU) or on hardware using wired logic. In addition, the various processing functions performed by the information processing apparatus 1 may be performed by a plurality of computers working together through cloud computing.

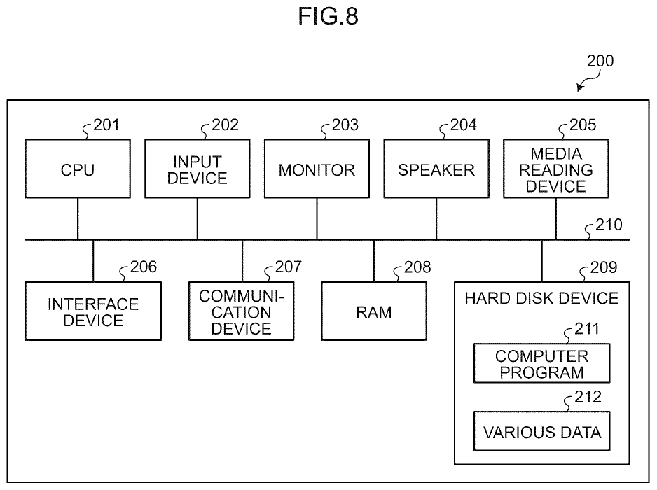

Meanwhile, the various processes described in the above embodiment can be implemented by executing a pre-prepared computer program on a computer. Therefore, the following is an example of a computer configuration (hardware) that executes a computer program with the same functions as the above embodiment. FIG. 8 is an explanatory diagram for explaining an example of the computer configuration.

As illustrated in FIG. 8, a computer 200 includes a CPU 201 that performs various arithmetic operations, an input device 202 that receives data input, a monitor 203, and a speaker 204. The computer 200 further includes a media reading device 205 for reading computer programs and the like from storage media, an interface device 206 for connecting to various devices, and a communication device 207 for communication connection to external devices in a wired or wireless manner. The computer 200 further includes a RAM 208 for temporarily storing various information and a hard disk device 209. In addition, the components 201 to 209 in the computer 200 are connected to a bus 210.

The hard disk device 209 stores a computer program 211 for performing various processes in the functional configurations (for example, the first learning unit 51, the second learning unit 52, and the inference unit 53) described in the above embodiment. The hard disk device 209 further stores various data 212 that are referenced by the computer program 211. The input device 202, for example, receives input of operating information from an operator. The monitor 203, for example, displays various screens operated by the operator. The interface device 206 is connected, for example, to a printing device and the like. The communication device 207 is connected to a communication network such as a local area network (LAN), and exchanges various information with external devices via the communication network.

The CPU 201 reads the computer program 211 stored in the hard disk device 209, loads the read computer program 211 to the RAM 208, and executes the loaded computer program 211, thereby performing various processes related to the above functional configurations (for example, the first learning unit 51, the second learning unit 52, and the inference unit 53). Note that the computer program 211 does not have to be stored in the hard disk device 209. For example, the computer program 211 stored in a storage medium readable by the computer 200 may be read and executed. For example, the storage medium readable by the computer 200 corresponds to a portable storage medium such as a CD-ROM, a DVD disk, and a universal serial bus (USB) memory, a semiconductor memory such as a flash memory, a hard disk drive, and the like. In addition, the computer program 211 may be stored in devices connected to a public line, the Internet, a LAN, and the like, and the computer 200 may read the computer program 211 from these devices, and execute the read computer program 211.

According to one embodiment, the sensory evaluation of an inspection target can be obtained nondestructively and easily.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer-readable recording medium having stored therein an inference processing program causing a computer to perform processes of:
acquiring target analysis information indicating physical and chemical analysis results corresponding to food being an inspection target by inputting an inspection image from a nondestructive inspection on the food being the inspection target to a first machine learning model trained by machine learning using a first data set of training data that associates an inspection image from a nondestructive inspection on food with first analysis information indicating physical and chemical analysis results for the food; and
inferring sensory evaluation results corresponding to the food being the inspection target by inputting the acquired target analysis information to a second machine learning model trained by machine learning using a second data set of training data that associates second analysis information indicating physical and chemical analysis results for the food with sensory evaluation results for the food.

2. The non-transitory computer-readable recording medium according to claim 1, wherein the first machine learning model is trained by the machine learning by using information obtained by dimensionally compressing the first analysis information by an autoencoder.

3. The non-transitory computer-readable recording medium according to claim 1, wherein the inspection image is an ultrasonic image obtained by ultrasonic exploration.

4. The non-transitory computer-readable recording medium according to claim 1, wherein the process of inferring includes outputting the target analysis information together with the sensory evaluation results.

5. A non-transitory computer-readable recording medium having stored therein a machine learning program causing a computer to perform processes of:
by machine learning using a first data set of training data that associates an inspection image from a nondestructive inspection on first food with first analysis information indicating physical and chemical analysis results for the first food, training a first machine learning model that outputs target analysis information indicating physical and chemical analysis results corresponding to an inspection target in response to reception of an inspection image from a nondestructive inspection on the inspection target; and
by machine learning using a second data set of training data that associates second analysis information indicating physical and chemical analysis results for second food with sensory evaluation results for the second food, training a second machine learning model that outputs sensory evaluation results corresponding to the inspection target in response to reception of the target analysis information of the inspection target.

6. The non-transitory computer-readable recording medium according to claim 5, wherein the process of training the first machine learning model includes training the first machine learning model by the machine learning using information obtained by dimensionally compressing the first analysis information by an autoencoder.

7. An inference processing method for performing, by a computer, processes of:
acquiring target analysis information indicating physical and chemical analysis results corresponding to an inspection target by inputting an inspection image from a nondestructive inspection on the inspection target to a first machine learning model trained by machine learning using a first data set of training data that associates an inspection image from a nondestructive inspection on first food with first analysis information indicating physical and chemical analysis results for the first food; and
inferring sensory evaluation results corresponding to the inspection target by inputting the acquired target analysis information to a second machine learning model trained by machine learning using a second data set of training data that associates second analysis information indicating physical and chemical analysis results for second food with sensory evaluation results for the second food.

8. The inference processing method according to claim 7, wherein the first machine learning model is trained by the machine learning by using information obtained by dimensionally compressing the first analysis information by an autoencoder.

9. The inference processing method according to claim 7, wherein the inspection image is an ultrasonic image obtained by ultrasonic exploration.

10. The inference processing method according to claim 7, wherein the process of inferring includes outputting the target analysis information together with the sensory evaluation results.

11. A machine learning method for performing, by a computer, processes of:
by machine learning using a first data set of training data that associates an inspection image from a nondestructive inspection on first food with first analysis information indicating physical and chemical analysis results for the first food, training a first machine learning model that outputs target analysis information indicating physical and chemical analysis results corresponding to an inspection target in response to reception of an inspection image from a nondestructive inspection on the inspection target; and
by machine learning using a second data set of training data that associates second analysis information indicating physical and chemical analysis results for second food with sensory evaluation results for the second food, training a second machine learning model that outputs sensory evaluation results corresponding to the inspection target in response to reception of the target analysis information of the inspection target.

12. The machine learning method according to claim 11, wherein the process of training the first machine learning model includes training the first machine learning model by the machine learning using information obtained by dimensionally compressing the first analysis information by an autoencoder.

13. An information processing apparatus comprising a control unit that performs processes of:
acquiring target analysis information indicating physical and chemical analysis results corresponding to an inspection target by inputting an inspection image from a nondestructive inspection on the inspection target to a first machine learning model trained by machine learning using a first data set of training data that associates an inspection image from a nondestructive inspection on first food with first analysis information indicating physical and chemical analysis results for the first food; and
inferring sensory evaluation results corresponding to the inspection target by inputting the acquired target analysis information to a second machine learning model trained by machine learning using a second data set of training data that associates second analysis information indicating physical and chemical analysis results for second food with sensory evaluation results for the second food.

14. The information processing apparatus according to claim 13, wherein the first machine learning model is trained by the machine learning by using information obtained by dimensionally compressing the first analysis information by an autoencoder.

15. The information processing apparatus according to claim 13, wherein the inspection image is an ultrasonic image obtained by ultrasonic exploration.

16. The information processing apparatus according to claim 13, wherein the process of inferring includes outputting the target analysis information together with the sensory evaluation results.

17. An information processing apparatus comprising a control unit that performs processes of:
by machine learning using a first data set of training data that associates an inspection image from a nondestructive inspection on first food with first analysis information indicating physical and chemical analysis results for the first food, training a first machine learning model that outputs target analysis information indicating physical and chemical analysis results corresponding to an inspection target in response to reception of an inspection image from a nondestructive inspection on the inspection target; and
by machine learning using a second data set of training data that associates second analysis information indicating physical and chemical analysis results for second food with sensory evaluation results for the second food, training a second machine learning model that outputs sensory evaluation results corresponding to the inspection target in response to reception of the target analysis information of the inspection target.

18. The information processing apparatus according to claim 17, wherein the process of training the first machine learning model includes training the first machine learning model by the machine learning using information obtained by dimensionally compressing the first analysis information by an autoencoder.
